(19) United States
(12) Patent Application Publication
(10) Pub. No.: US 2018/0014636 A1
(43) Pub. Date: Jan. 18, 2018

(54) MULTI-USER STATION FOR THE PREPARATION OF FOODS

(71) Applicant: ENTERPRISE SRL, BOLZANO (IT)

(72) Inventor: FEDERICA BERTANI, BOLZANO (IT)

(21) Appl. No.: 15/547,823

(22) PCT Filed: Jan. 26, 2016
(86) PCT No.: PCT/IB2016/050370

§ 371 Date: Aug. 1, 2017

(30) Foreign Application Priority Data
Feb. 4, 2015 (IT) RM2015A000047

(51) Int. Cl. A47B 33/00; H05B 6/12; A47B 77/02; A47B 77/06

(52) U.S. Cl. CPC A47B 33/00; H05B 6/1209; A47B 77/022; A47B 77/06

(57) ABSTRACT

A multi-user station (1) is described for the preparation of foods adapted and configured to be used simultaneously by two users (U1,U2), comprising an island counter having a work surface (2) and a support structure (3) of the work surface (2), wherein the work surface, in plan view, has a first side (LI) that is convex and intended in use to be facing the two users (U1,U2), wherein the multi-user station (1) includes two taps (6), two sinks (7) built-in to the work surface (2) and at least two heating units (8).

### SCOPE OF THE INVENTION

The present invention relates to the technical field of stations for the preparation of foods and in particular concerns a multi-user station for the preparation of foods.

### STATE OF THE ART

Television programmes talking, in very different ways, about food, recipes, food and wine and where demonstrations of food preparation practices are provided, are increasingly common. In such transmissions, professional cooks and/or chefs and/or competitors and/or cooking enthusiasts are generally involved who prepare food live or recorded. Also on the web there are increasing numbers of videos showing food preparation operations carried out according to the relative recipes.

In the above programmes, stations are generally used for the preparation of foods which comprise work tops, sinks with taps, cooking devices comprising one or more heating units. In the case in which there are multiple simultaneous preparations by different people, separate stations arranged at a distance from each other, for example aligned in one or more rows and/or one or more columns, are normally used. It has been noted that the aforesaid stations of the prior art do not allow an effective simultaneous filming of the preparation operations.

The purpose of the present description is to provide a station for the preparation of foods which solves or at least partly reduces the drawbacks described above with reference to the stations of the prior art.

Such purpose is achieved by means of a multi user station for the preparation of food as generally defined in claim 1. Preferred and advantageous embodiments of the aforesaid multi user station are defined in the appended dependent claims.

The invention will be better understood from the following detailed description of a particular embodiment, made by way of a non-limiting example with reference to the appended drawings, briefly described in the following paragraph.

### BRIEF DESCRIPTION OF THE DRAWINGS

FIG. 1 shows a first perspective view of a first embodiment of a multi-user station for the preparation of foods.

FIG. 2 shows a second perspective view of the station in FIG. 1.

FIG. 3 shows a first plan view in elevation of the station in FIG. 1.

FIG. 4 shows a second plan view in elevation of the station in FIG. 1.

FIG. 5 shows a plan view of the station in FIG. 1.

FIG. 6 shows a first perspective view of a further preparation station usable together with the station in FIGS. 1 to 5 during cooking courses or lessons.

FIG. 7 shows a second perspective view of the further station in FIG. 6.

FIG. 8 shows a view in elevation of the further station in FIG. 6.

FIG. 9 shows a perspective assembly view comprising a plurality of multi-user stations of FIG. 1.

FIG. 10 shows a plan view of the assembly in FIG. 9.

FIG. 11 shows a schematic view from above of a system for the remote transmission of cooking courses or lessons comprising the station in FIG. 6 placed in a first area and the assembly of FIG. 9 placed in a second area.

### DETAILED DESCRIPTION

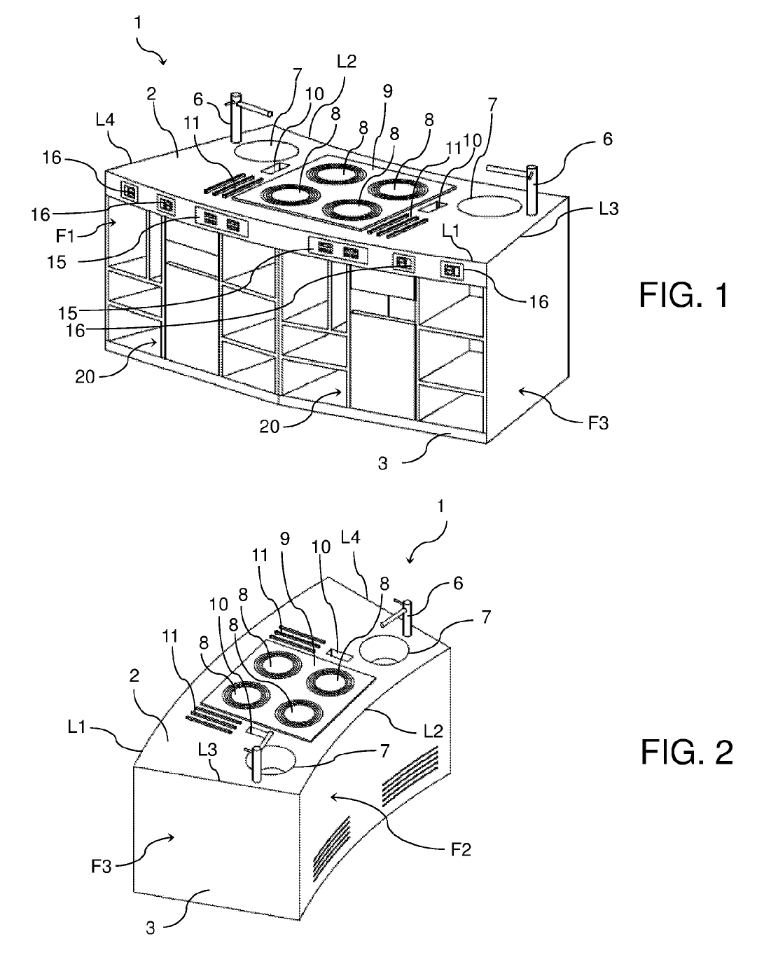

FIGS. 1-5 show a first embodiment by way of a non-limiting example of a multi-user station 1 for the preparation of foods.

In the example shown in FIGS. 1-5, without thereby introducing any limitation, the multi-user station 1 is adapted and configured to be used simultaneously by two users U1, U2 for the preparation of foods. The term preparation of foods is understood to mean the performance of various operations to prepare the ingredients of the dishes to be cooked and to cook the dishes, including by way of a non-limiting example, in various combinations or separately from each other: cleaning operations of the ingredients, measuring, washing, cutting, cooking of the dishes, arrangement on the plate and decoration of the dishes.

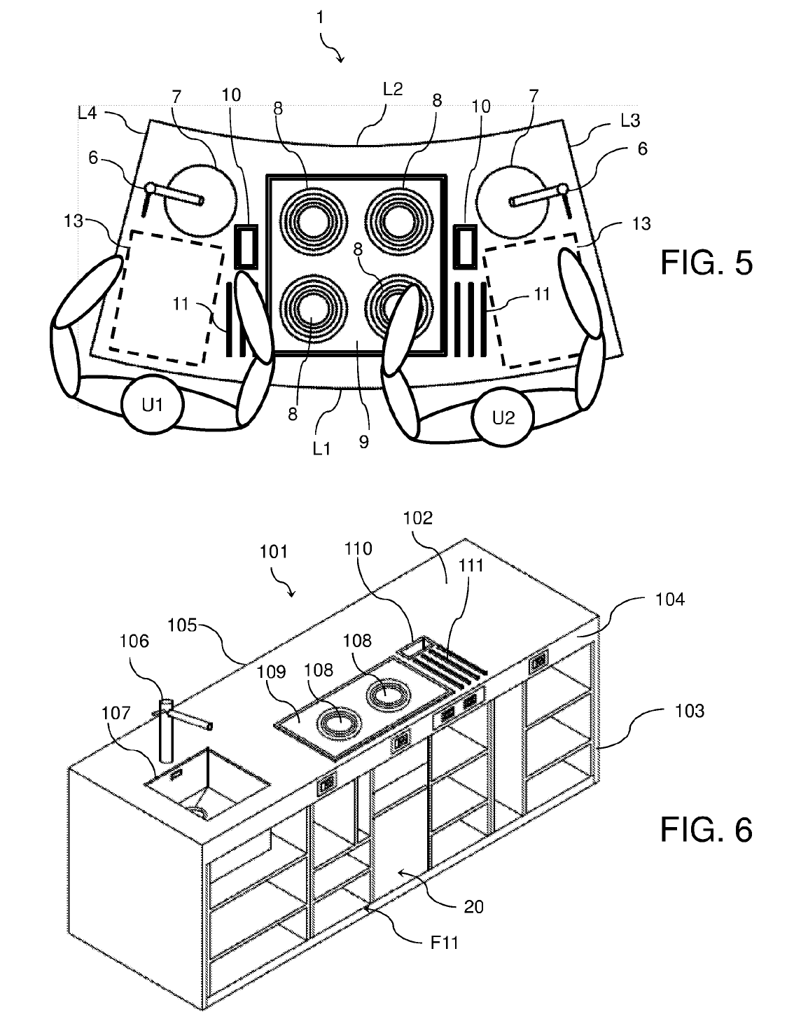

The multi-user station 1 comprises an island counter having a work surface 2 and a support structure 3 of the work surface 2. The work surface 2, in plan view, has a first side L1 that is convex and intended in use to be facing the two users U1, U2, (shown schematically in FIG. 5). Convex is understood to mean convex with respect to points belonging to the work surface 2.

The multi-user station 1 includes two taps 6, for example provided with a mixer tap, two sinks 7 built-in to the work surface 2, for example made of steel and at least two heating units 8. Preferably the taps 8 are fixed to the work surface 2.

The work surface 2 may for example be made of steel, natural stone, quartz, wood or a synthetic material such as Corian®).

The support structure 3 of the work surface 2 is for example made of wood.

According to one embodiment, the heating units 8 are interposed between the sinks 7. This implies that the sinks 7 are laterally outermost and the heating units 8 are centrally arranged between the sinks 7.

According to one embodiment, the work surface 2, in plan view, has a second side L2 that is concave and opposite to the convex first side L1. Concave is understood to mean concave with respect to points belonging to the work surface 2. Preferably the work surface 2 has a third L3 and fourth L4 side that are rectilinear and opposite to each other and that extend between the convex first side L1 and the concave second side L2.

In the particular example shown in the drawings, the first L1 and the second side L2 of the work surface are two arcs spaced from each other and having the same radius of curvature with respect to an axis perpendicular to the work surface 2, for example with respect to a vertical axis. According to an alternative embodiment, the second side L2 could be for example a flat side.

According to an alternative embodiment, the first side L1, and/or the second side L2 could extend not according to the continuous curved lines, as shown in the example represented in the drawings, but according to broken lines.

According to an advantageous embodiment, the sinks are closer to the second side L2 than to the first side L1. Preferably, between the first side L1, and each of the sinks 7, the work surface 2 comprises respectively a first 13 and a second work area 13 (dotted line areas in FIG. 5) arranged on opposite sides to each other with respect to the heating units 8. Preferably the work areas 13 are planar areas. Preferably, one or more raised elements 11, for example in metal or a thermally insulating rubber, which can be used both as an abutment for supporting any utensils, such as a cutting board, or as temporary support areas for hot objects, such as pots or pans, to prevent said objects from damaging the work surface 2 are attached to at least one side of the work areas 13 on the work surface 2.

According to an advantageous embodiment, the heating units 8 are induction burners. In the example shown in the drawings, the heating units 8 are four induction burners, arranged at the vertices of a quadrilateral and integrated in an induction hob 9 fixed to the work surface 2. It is clear that in such embodiment each user has at his disposal two induction burners.

According to one embodiment, the multi-user station 1 further comprises two object-holder trays 10 built-in to the work surface 2. These object-holder trays 10, for example made of steel, preferably have an access mouth arranged flush, or substantially flush, with the work surface 2. These trays 10 make it possible to stand containers of seasonings, such as bottles of oil, vinegar or sauces in a vertical position and out of sight, thus preventing such bottles from being rested on the work surface 2 and obstructing the view at least partially with respect to an observation point located in front of the second side L2.

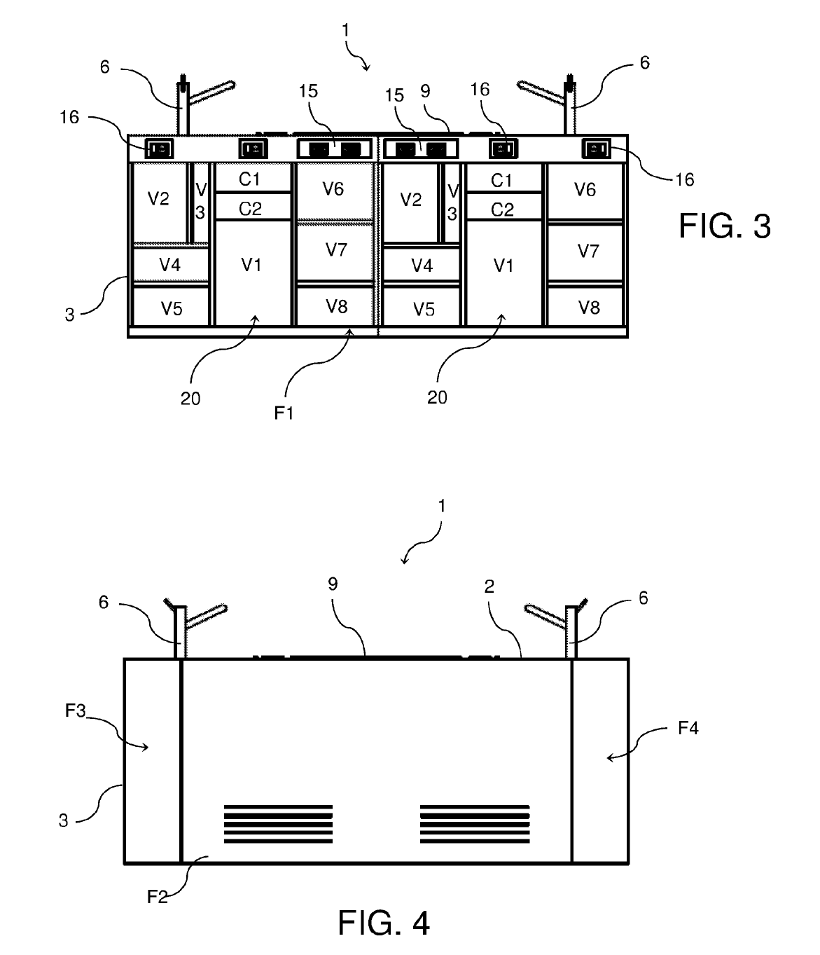

With reference to FIG. 3, according to an advantageous embodiment, under the first side L1, the support structure 3 comprises a first face F1 comprising two arrays of identical compartments 20, one for each of two simultaneous users U1, U2. Said compartments may be for example be open compartments, drawers, sliding baskets, compartments closed by a respective door, etc. Preferably the first face F1 is also convex and may be a curved face or may be a face which when seen from above or below follows a broken line. The support structure 3 comprises a second face F2 opposite the first face F1 and preferably concave. The support structure 3 also comprises a third F3 and a fourth face F4 opposite each other and which extend between the first F1 and the second face F2. Preferably the third face F3 and the fourth face F4 are both planar faces.

According to a preferred embodiment, control elements 15 of the heating units 8 are fixed to the first face F1, preferably at least one control element for each user U1, U2. More preferably power supply sockets 16 are fixed to the first face F1, at least one for each user U1, U2, to allow the power supply of tools such as food mixers, blenders, electric knives, etc.

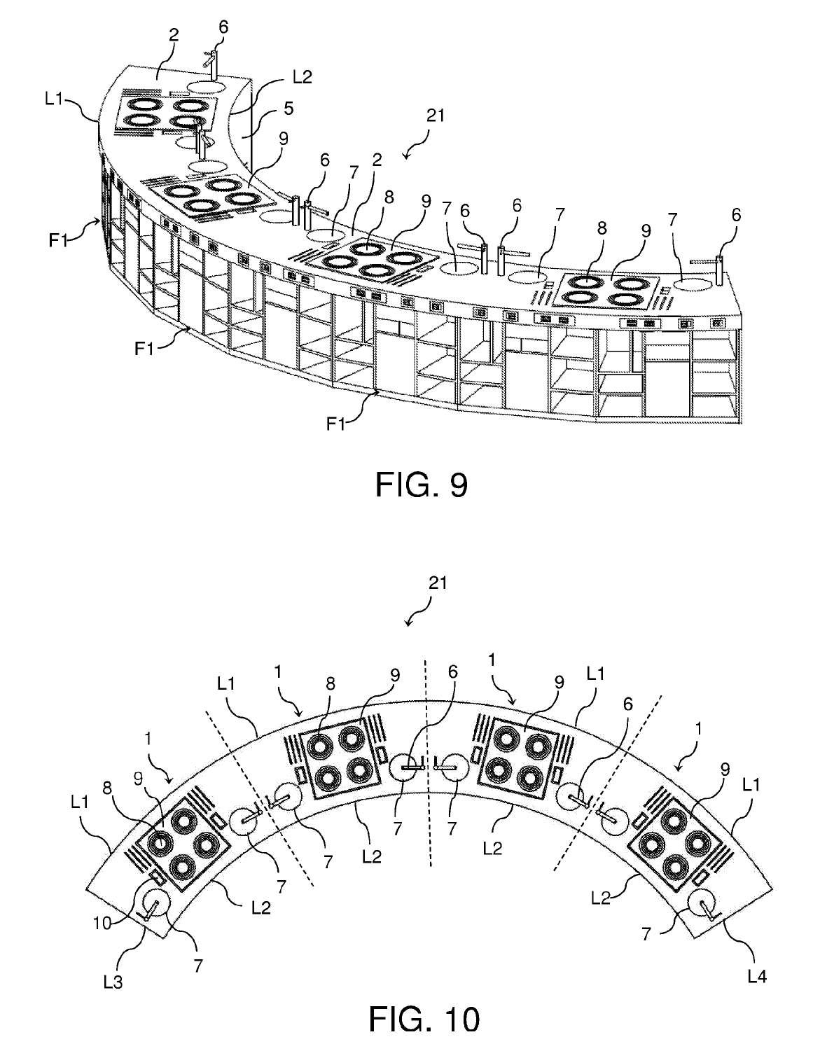

The multiuser station 1 described above can be used as a stand alone station, thus usable simultaneously by two users U1, U2, or with reference to FIGS. 9 and 10 may be used in combination with other multi-user stations 1 as a basic element, or module, to form a monobloc or modular assembly 21, usable simultaneously by a number of users equal to integer multiples of two. In this case the various multi-user stations 1 described above are arranged side by side and juxtaposed in two by two so that the first side L1 of each multi-user station 1 and the first side L1 of an adjacent multi-user station 1 are aligned to form a continuous convex side. In the example of FIGS. 9 and 10 an assembly 21 consisting of four multi-user stations 1 described with reference to FIGS. 1-5 and usable by eight users simultaneously, is shown. In FIG. 10 the four adjacent multi-user stations 1 are shown represented by dashed separate virtual lines.

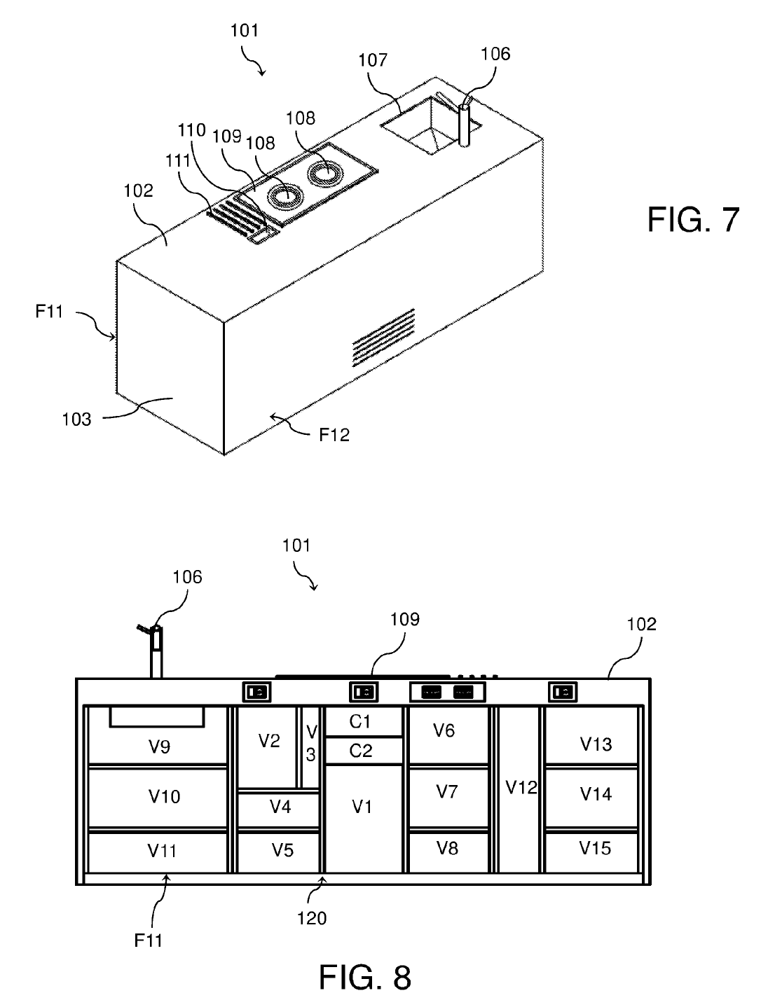

A multiuser station 1 of the type described above with reference to FIG. 1 or 5 or even an assembly 21 described with reference to FIGS. 9 and 10, although also suitable for use in the home for example as kitchen island units, in show rooms or catering premises, can be advantageously used in a system for the simultaneous delivery of cooking courses or lessons to a plurality of students. In this case, with reference to FIGS. 6-8, it is possible to associate use of the multi-user station 1 with a further station 101 adapted and configured to be used by the teacher of the class or cookery course, for example by a chef. In the example shown said further station 101 has approximately the same elements as the multi-user station, such as an island counter comprising a work surface 102, a support structure 103 of the work surface 102, two heating units 108 belonging to an induction plate 109, a tap 106, a sink 107, an object holder tray 110 and the raised elements 111. The user of the further station 101 (for example a teacher) has in practice at his/her disposal at least the same elements provided on the multi-user station 1 for each user (i.e. for each student).

However, the multi-user station 1 may be any shape, for example having the general shape of a parallelepiped, as shown in FIGS. 6-8. In particular, in the case already described above in which the support structure 3 of the multi-user station 1 comprises a first face F1 located under the first side L1, and comprising a first and a second arrays 20 of identical and adjacent compartments, it is advantageous to provide that the further station 101 for the preparation of food intended for use by the teacher of the courses or lessons, comprises a face F11 comprising an array of compartments identical to said first 20 and second 20 array of compartments. The above face F11 is the face of the further station 101 which is facing the user, i.e. the teacher, during normal use of the further station 101, while in the drawings the opposite face is the face F12. With reference to Figure it may be seen, in particular, that in the example shown each array 20 of the multi-user station 1 in the example comprises a compartment V1 closed by a door, seven open compartments V2-V8 and two drawers C1, C2. With reference to FIG. 8 it may be seen that the further station 101 also comprises an array identical to the arrays 20 of the multi-user station 1, in FIG. 3, in fact the array 120 also comprises a compartment V1 closed by a door, seven open compartments V2-V8 and two drawers C1, C2. This does not exclude that the further station 101 may include additional compartments, it is in fact to be noted that in FIG. 8, 6 additional compartments V9-V15 are shown. The provision of identical arrays 20 in the multi-user station 1 and in the further station 101 advantageously allows the teacher, for example the chef, to give students particularly easy and clear directions on where to find kitchen utensils or ingredients to be used in the lessons or courses.

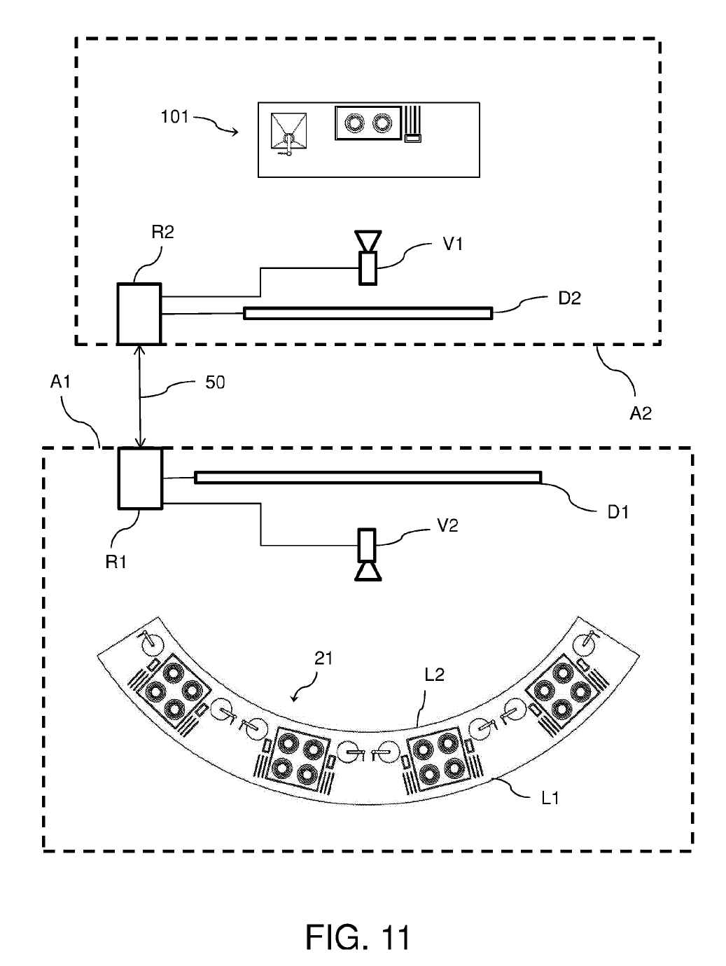

In the system described above both the multi-user station 1 and the further station 101 can be arranged in the same environment. However, with reference to FIG. 11, the system described above is advantageously adapted for delivering remote courses or lessons, for example by providing that one multi-user station 1 is placed in a first area A1 and that the further station 101 is placed in a second area A2, separate from the first area A1. In this case the system comprises:

a first display device D1 placed in the first area A1 facing the second side L2 of the multi-user station 1 (or of the assembly 21);

a first filming device V1 placed in the second area A2 and adapted to film and record the further station 101 to acquire a first video;

a transmission system R1,R2,50 adapted and configured to transmit the first video to the first area A1 for its reproduction on the first display device D1.

For example, the aforesaid transmission system includes two routers R1, R2 and a connection 50 via a telecommunications network, such as satellite or wired, for example the Internet. With the system described above, different users, i.e. various students can simultaneously attend a cookery course or lesson, where the teacher is in the second area A2, for example in one place and where the students are in the first area A1 for example in a different place.

According to an advantageous embodiment it is possible to provide that the aforesaid system also comprises:

a second display device D2 placed in the second area A2;

a second filming device V2 placed in the first area A1 and suitable to film and record the multi-user station (1) to acquire a second video.

In the aforesaid embodiment, the transmission system R1, R2, 50 is also adapted and configured to transmit the second video to the second area A2 for reproduction on the second display device D2. Advantageously, this allows both students to watch the lesson given by the teacher and the teacher to observe students during the preparation of food. Clearly, it is advantageous to provide for each area A1, A2 several filming devices for example, to have the possibility of filming the entire scene or details, possibly providing a production room. Furthermore, it is advantageous to acquire audio signals in addition to videos so as to ensure a full interactivity between the two areas A1 and A2.

From the above description it is evident that the multi-user station described above makes it possible to fully achieve the intended purposes in terms of overcoming the drawbacks of the prior art.

Without prejudice to the principle of the invention, the embodiments and construction details may be varied widely with respect to what has been described and illustrated purely by way of a non-limiting example, without thereby departing from the scope of the invention as defined in the appended claims.

1. Multi-user station (1) for the preparation of foods adapted and configured to be used simultaneously by two users (U1,U2), comprising an island counter having a work surface (2) and a support structure (3) of the work surface (2), wherein the work surface, in plan view, has a first side (LI) that is convex and intended in use to be facing the two users (U1,U2), wherein the multi-user station (1) includes two taps (6), two sinks (7) built-in to the work surface (2) and at least two heating units (8) .

2. Multi-user station (1) according to claim 1, wherein the heating units (8) are interposed between the sinks (7).

3. Multi-user station (1) according to claim 1, wherein the work surface (2), in plan view, has a second side (L2) that is concave and opposite the convex first side (LI).

4. Multi-user station according to claim 3, wherein the work surface (2) has a third (L3) and fourth (L4) side that are rectilinear and opposite to each other and that extend between the convex first side (LI) and the concave second side (L2).

5. Multi-user station (1) according to claim 1, wherein the sinks (7) are closer to the second side (L2) than to the first side (LI).

6. Multi-user station (1) according to claim 1, wherein between the first side (LI) and each of said sinks (5), the work surface (2) comprises, respectively, a first work area (13) and a second work area (13) arranged on opposite sides of the heating units (8).

7. Multi-user station (1) according to claim 1, wherein the heating units (8) are induction burners.

8. Multi-user station (1) according to claim 7, wherein the heating units (8) are four induction burners, arranged at the vertices of a quadrilateral and integrated in an induction hob (9) fixed to the work surface (2).

9. Multi-user station (1) according to claim 1, further comprising two object-holder trays (10) built-in to the work surface (2).

10. Monobloc or modular assembly (21) comprising a plurality of multi-user stations (1) according to claim 1, placed alongside one another two-by-two so that the first side (LI) of each multiuser station (1) and the first side (LI) of an adjacent multi-user station (1) form a continuous convex side.

11. System for delivering cooking courses or lessons, comprising at least one multi-user station (1) according to claim 1, intended to be used by participants of the course or lessons, wherein the support structure (3) comprises a first face (FI) positioned at the bottom of said first side (LI) and comprising a first and a second array (20) of compartments identical to one another and side-by-side, and wherein the system also comprises a further station (101) for the preparation of food intended to be used by a teacher of the lessons or courses, wherein said further station (101) comprises a face (FII) comprising an array (20) of compartments identical to said first array (20) and second array (20) of compartments.

12. System according to claim 11, wherein the at least one multi-user station (1) is arranged in a first area (AI) and wherein a further station (101) is arranged in a second area (A2) separated from the first area (Al) and wherein the system comprises:
a first display device (DI) placed in the first area (AI) in front of the first side (LI);
a first filming device (VI) placed in the second area (A2) and adapted to film and record the further station (101) to acquire a first video;
a transmission system (R1,R2,50) adapted and configured to transmit the first video for reproduction on the first display device (Dl).

13. System according to claim 12, comprising:
a second display device (D2) placed in the second area (A2);
a second filming device (V2) placed in the first area (AI) and adapted to film and record said multi-user station (1) to acquire a second video;
and wherein the transmission system (R1,R2,50) is also adapted and configured to transmit the second video for reproduction on the second display device (D2).
